(19) United States
(12) Patent Application Publication
(10) Pub. No.: US 2014/0214229 A1
(43) Pub. Date: Jul. 31, 2014

(54) LOW-FREQUENCY PWM APPLIANCE RESPONSE TO DEMAND RESPONSE MANAGEMENT SIGNALS

(71) Applicant: GENERAL ELECTRIC COMPANY, Schenectady, NY (US)

(72) Inventors: William Jerome Burke, Louisville, KY (US); Jeff Donald Drake, Louisville, KY (US); Charles Ray Smith, Simpsonville, SC (US); David Joseph Najewicz, Prospect, KY (US)

(73) Assignee: GENERAL ELECTRIC COMPANY, Schenectady, NY (US)

(21) Appl. No.: 13/752,433

(22) Filed: Jan. 29, 2013

(51) Int. Cl. G05F 5/00

(52) U.S. Cl. CPC G05F 5/00
USPC 700/296

(57) ABSTRACT

The present subject matter relates to energy management. Home energy management (HEM) devices are directed from a central control system to modify energy usage among appliances/loads within individual homes to meet energy source demand limitations. The HEM devices may work in cooperation with a group of such devices as a unit to negotiate with the central control system and then individually to control energy usage for their separately controlled home appliances/loads to meet group negotiated aggregate energy usage modification, for example, usage reductions so as to minimized peak usage demands on the energy source.

### FIELD OF THE INVENTION

This disclosure relates generally to energy management systems for homes. More particularly, the disclosure relates to operation of home energy management systems in response to demand response signals.

### BACKGROUND OF THE INVENTION

Certain utility companies are experiencing a shortage of electrical generating capacity due to increasing customer demand for electricity. In particular, such utility companies may be unable to meet their customers' demand for electricity during peak demand hours. Increasing electrical generating capacity to meet the shortfall can be difficult due to increasing fuel prices. As a result, utility companies can be forced to buy electricity to meet their customers' demands. If peak demand hours can be reduced, then utility companies and their customers can realize a potential cost savings, and the peak load that the utility companies have to accommodate can also be lessened.

Certain energy management systems include features for deactivating power consuming devices during the on-peak hours. Such energy management systems can determine when variable electricity-pricing schemes go into effect via schedules published by utility companies and inputted by customers or via signals sent by utility companies, e.g., over a wireless network or through a phone network, directly to the energy management systems. However, inputting schedules manually can be tedious and time consuming. Similarly, energy management systems relying upon utility company input to function properly can function improperly if the utility company fails to deliver the schedules as expected.

Alternative energy management plans provide systems and methods with time of use (TOU) and/or demand response management systems (DRMS) energy programs. The present disclosure finds particular application to utility systems and appliances configured to manage energy loads to consumers through a communicating consumer control device, such as a home energy manager (HEM), programmable communicating thermostat (PCT), appliance controller, or the like.

There is a need to provide a system that can automatically operate power consuming devices in order to reduce consumer's electric bills and also to reduce the load on generating plants during peak hours. Active and real time communication of energy costs of appliances to the consumer may enable informed choices of operating the power consuming functions of the appliance but in many instances consumers may not be present to make necessary usage adjustments or may simply ignore provided information.

In view of these and other issues, there is a need to provide an improved system that can enable automatic control of power consuming devices during a DRMS event, and thus, provide opportunity for utility companies to better meet the needs of their customers.

### BRIEF DESCRIPTION OF THE INVENTION

Additional aspects and advantages of the invention will be set forth in part in the following description, or may be apparent from the description, or may be learned through practice of the invention.

The present subject matter relates to energy management systems. In accordance with some embodiments, such systems comprise a central control system including a demand management system and a plurality of home energy management systems in communication with the central control system. In such systems each of the plurality of home energy management systems is configured for communications with at least one home appliance. In accordance with the present subject matter, the demand management system is configured to transmit demand response signals to each of the plurality of home energy management systems where such signals include instructions to modify overall system usage demand, and wherein each of the plurality of home energy management systems is configured to instruct the at least one home appliance to modify its energy consumption.

The present subject matter also relates to a method for managing energy usage. In accordance with such method, the overall energy demand in at least a portion of a utility system is monitored from a central control location and demand modification signals are transmitted to a plurality of home energy management systems that then transmit the demand modification signals to at least one home appliance instructing such appliance to modify its energy consumption.

The present subject matter further relates to a power distribution and control system. In accordance with such system there is provided a central control system, a source of power, a plurality of power consumption locations having at least one power consuming device and an energy management device at each such location, and an advanced metering infrastructure configured to provide communications between the central control system and each the energy management devices. According to such system the central control system is configured to monitor power flow from the source of power to the plurality of power consumption locations and to direct said energy management device located at each of said plurality of power consumption locations to modify the energy usage of at least one power consuming device located at each of the plurality of power consumption locations.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides an overview of a Demand Response Managements System (DRMS) in accordance with an exemplary embodiment of the present subject matter;

FIG. 2 illustrates exemplary sequences of Low-Frequency Pulse Width Modulation (PWM) Appliance Response signals produced in response to DRMS signals in accordance with the present subject matter; and

FIG. 3 illustrates exemplary sequences of Home Pulse Width Modulation (PWM) responses produced in response to DRMS signals in accordance with the present subject matter.

Repeat use of reference characters throughout the present specification and appended drawings is intended to represent same or analogous features or elements.

### DETAILED DESCRIPTION OF THE INVENTION

As discussed in the Summary of the Subject Matter section, the present subject matter is particularly concerned with home energy management systems and methodologies for responding to Demand Response Management requests.

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

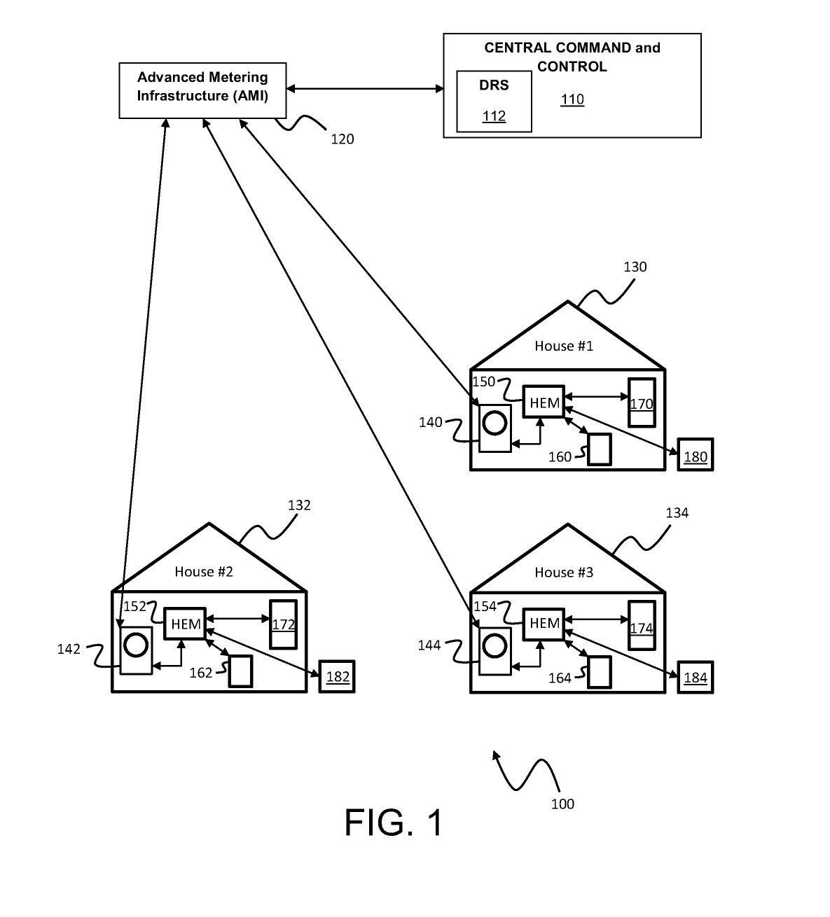

With initial reference to FIG. 1, there is provided an overview of a Demand Response Managements System (DRMS) 100 in accordance with an exemplary embodiment of the present subject matter. In accordance with exemplary embodiments of the present subject matter, Demand Response Managements System (DRMS) 100 includes a Central Command and Control system 110 that, from time to time may send, by way of a Demand Response Server 112, requests to modify overall system usage demand. Such request are sent from Demand Response Server 112 as system level signals by way of Demand Response Server 112 to the Advanced Metering Infrastructure (AMI) 120 and then to Home Energy Management (HEM) systems 150, 152, 154 located in association with individual homes representatively illustrated as houses 130, 132, 134 (House #1, House #2, House #3).

Those of ordinary skill in the art will appreciate that AMI 120 may correspond to a vast number of devices including transmission lines over which power and possibly communications signals may flow to a large number of individual homes and other facilities or locations. AMI 120 may also include various communications related features including wireless communications or power line communications systems that may be employed to exchange information between individual home or other locations and a central facility relating to consumption and control of such utilities all in accordance with well-known and commonly used AMI arrangements as are fully understood by those of ordinary skill in the art. Such communications systems may also be used in conjunction with the present subject matter to transmit demand request signals from Demand Response Server 112 to individual home energy management systems.

It should also be appreciated that while the present disclosure is particularly directed to home energy management, such may also be applied to energy management for other facilities including without limitation, commercial and public facilities whose energy demand may also be controlled based on the technology of the present subject matter. Thus in the context of the present disclosure, the use of the terms “home” or “house” is fully intended to include other structures whether used as a residential facility or for some other purpose as long as such facility contains or has associated therewith, energy consuming appliances whose energy consumption may be controlled in accordance with the present subject matter.

With continued reference to FIG. 1, there are representatively illustrated three houses 130, 132, 134 each of which is supplied with electrical power from a utility and includes associated therewith systems providing bidirectional communications with Central Command and Control 110 by way of AMI 120. In an exemplary arrangement, homes 130, 132, 134 are each provided with an electric utility meter 140, 142, 144 containing metrology components as well as communication components that operate to monitor and report energy consumption information to Central Command and Control 110. Each home 130, 132, 134 is also provided with a Home Energy Management (HEM) system 150, 152, 154 configured to receive instructions from Central Command and Control 110, or, more specifically, from Demand Response Server 112. Such HEM systems 150, 152, 154 may then provide instructions to individual appliances associated with the individual homes 130, 132, 134. In an alternative configuration, HEM systems may be incorporated directly in electric utility meters 140, 142, 144 or, as illustrated, may correspond to stand alone units. Further it should be appreciated that while HEM systems 150, 152, 154 are illustrated as connected to various home appliances including representatively, dryers 160, 162, 164, refrigerators 170, 172, 174, and HVAC systems 180, 182, 184, such connections may correspond to either wired or wireless connections over which control signals may be uni-directionally or bi-directionally transmitted.

In accordance with the present subject matter, each home appliance 160, 162, 164, 170, 172, 174, 180, 182, 184 operates using synchronized low frequency Pulse Width Modulation (PWM) wherein Demand Response Server (DRS) 112 directly controls the maximum duty cycle (dcMax) using a single global command transmitted to all the HEM systems 150, 152, 154, that, in turn, control the dcMax of each appliance (device) in their respective homes 130, 132, 134. HEMs 150, 152, 154 are configured to communicate directly with DRS 112 by way of a two-way link through AMI 120. In this manner the DRS through individual HEMs is able to control the aggregated average operating power level at which each home appliance needs to operate to achieve a desire goal

In accordance with the present subject matter, when it is determined that a reduction in demand is necessary DRS 112 of the Demand Response Management System within the Central Command and Control system 110 will negotiate a kilowatt hour (kWh) reduction (or other desired demand, e.g., percentage reduction) over a fixed time period with each HEM 130, 132, 134 through a bid process. In accordance with such bid process, DRS 112 solicits consumption reduction bids and each HEM then estimates possible consumption reductions and makes a bid. DRS 112 may then accept bids or revise its solicitations to a lower reduction level, for example, if bids are not accepted. When bids are accepted, the individual HEMs 130, 132, 134 then controls the maximum duty cycle (dcMax) of each appliance in its respective home 130, 132, 134.

In accordance with one aspect of the present subject matter HEMs 150, 152, 154 are aware of the various products/appliances/loads that are on line and are able to monitor the overall home load via the AMI or alternatively through monitoring of their associated individual home utility meter. With this information, the HEMs may be configured to control their various respective appliances in several ways. In a first aspect, certain of the appliances may themselves contain operating software (firmware) that encompasses duty cycle control such that the HEM may direct such appliance to operate using a particular duty cycle based on the desired (accepted bid) reduction. The appliance itself can then operate under the specified criteria by lowering the load produced by the appliance using, for example, a randomized duty cycle method that may be incorporated into the appliance controller.

In some embodiments of the present subject matter, the duty cycle signal sent to the various appliances (loads) may correspond to a discreet level based on a standardized set of levels or, also possibly, on a continuous level. Other home appliances may not have such software included in their operating systems. In those instances the responsible HEM will generate a randomized duty cycle control signal and transmit such control signal to those appliances (loads), thus allowing them to respond in a manner similar to the appliances (loads) containing the embedded algorithm in their controllers.

In some other embodiments of the present subject matter, appliance may be installed in certain homes that include communications controllers including “sleep time” functionality. That is, such appliances may be in a sleep mode until the product (appliance) is activated. When such products are activated then the control signals for dcMax reduction will be sent either on an interval basis or a rolling “look ahead” basis containing estimated signals for the next several periods.

In accordance with a further aspect of the present subject matter individual HEMs 150, 152, 154 may employ a closed loop control approach to monitor their respective homes. According to such approach, the HEMs may be configured to adjust signals sent to individual appliances (loads) with the objective of meeting the overall demand reduction requested so that the entire home is managed as a single entity.

In a further aspect of the present subject matter, the DRMS may be configured to monitor the total load on various sub groups of load centers, that is, on a sub group of homes and adjust the signals sent to each sub group to adjust demand reduction requested for each sub group based on their ability to provide requested aggregate load reduction. In accordance with aspects of this portion of the present subject matter, HEMs 150, 152, 154 may be configured to form a network to communicate among each other and with the DRS 112. In this manner the HEMs form a Super-Organism Negotiation and Decision (SOND) group, that is, a sub group of HEMs among the large number of such devices associated with the AMI, wherein the DRS may negotiate a kilowatt hour (or other desired demand, e.g., percentage) reduction (or other adjustment/modification) over a fixed time period with the SOND. The HEMs in the SOND then decide (negotiate) among themselves how best to meet a negotiated aggregate level for the SOND.

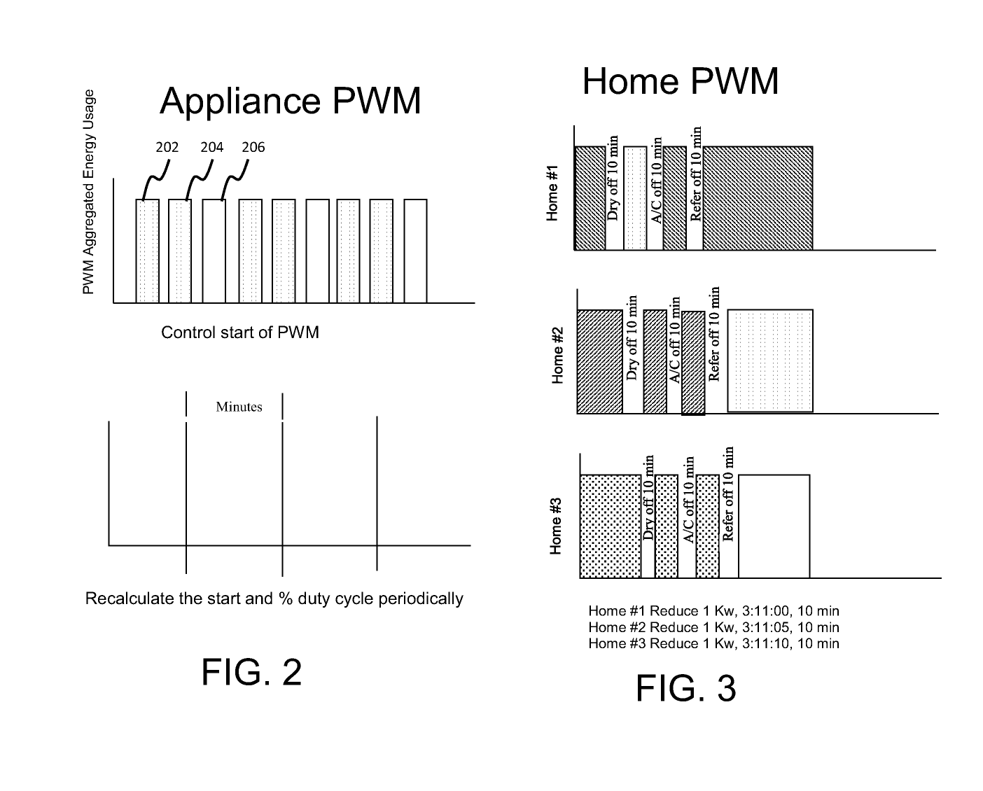

With present reference to FIGS. 2 and 3 there is illustrated respectively exemplary appliance and home PWM operations in accordance with the present subject matter, With respect to FIG. 2, there is illustrated an exemplary sequence of controlled start of PWM for a number of individual appliances 202, 204, 206 associated with an individual home. As shown, the PWM aggregated energy usage, per present disclosure, is controlled to a generally uniform level. FIG. 2 also illustrates that the calculation of the start of the PWM, i.e., the periodic percentage adjustment of duty cycle to maintain the desired aggregate level of energy usage may also be periodically recalculated. In an exemplary configuration, such recalculations may be performed on an every several minutes basis. While FIG. 2 is intended to initially illustrate operations with respect to appliances in an individual home, per previous discussion, regarding the SOND configuration, FIG. 2 may equally be indicative of HEM operation with respect to plural homes.

For example, as further illustrated in FIG. 3, the aggregated load reductions of individual homes forming a sub group of homes by virtue of a formed SOND may be controlled so that not only the individual homes overall (collectively) but also the appliances within each home are controlled to maintain a SOND negotiated energy usage level. For example, as illustrated in FIG. 3, house #1 may begin HEM controlled energy usage and then, after a controlled period of time, turn off a dryer for a predetermined time period, followed by controlled interruptions of the operation of HVAC systems and home refrigerators. In exemplary embodiments of the present subject matter such “off” periods may be set to 10 minutes. Alternative times, of course, may be set as well as differing times based on the particular appliances to be controlled.

With further reference to FIG. 3, it will be appreciated that in accordance with the present disclosure, the other houses (house #2 and house #3) that are part of the SOND similarly control, via their respective HEM, their appliances to be cycled off for predetermined times but do so in concert with the HEM controlling house #1 so that not all of the controlled appliances in all of the homes of the sub group that formed the SOND are on at the same time. In this manner the SOND negotiated reduction for the sub group may be effected.

The present subject matter provides several benefits including the ability of the system operator to control the aggregate residential load and reshape the load curve. The use of these control techniques will allow mitigation of peak loads, control of transient loads at the end of the period and distribution of deferred loads in the post peak period.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An energy management system, comprising:
a central control system including a demand management system; and
a plurality of home energy management systems in communication with said central control system, each of said plurality of home energy management systems configured for communications with at least one home appliance,
wherein said demand management system is configured to transmit demand response signals to each of said plurality of home energy management systems including instructions to modify overall system usage demand, and wherein each of said plurality of home energy management systems is configured to instruct the at least one home appliance to modify its energy consumption.

2. A system as in claim 1, wherein said at least one home appliance is configured to control its own energy usage in accordance with instructions from its home energy management system.

3. A system as in claim 2, wherein said at least one home appliances is configured to operate using a duty cycle based on criteria provided by instructions from its home energy management system.

4. A system as in claim 1, wherein said at least one home appliance is configured for power control based on instructions from its home energy management system and said home energy management system is configured to generate duty cycle control signals for transmission to said at least one home appliance.

5. A system as in claim 1, further comprising:
at least one additional home appliances in communications with said at least one of said plurality of home energy management systems,
wherein said home energy management system is configured to control each of the appliances with which it communicates to provide control of the appliances to achieve an aggregate energy usage in accordance with instruction from said demand management system.

6. A system as in claim 1, wherein a sub group of said plurality of home energy management systems is configured to establish a communications network among each other and to negotiate as a sub group with said demand management system to achieve a desired aggregate level demand adjustment.

7. A system as in claim 6, wherein said sub group of said plurality of home energy management systems is configured to negotiate among themselves how to meet the negotiated aggregate level.

8. A system as in claim 7, wherein said sub group of said plurality of home energy management systems is configured so that individual homes are collectively controlled with the appliances within each home to maintain a sub group negotiated energy usage level.

9. A method for managing energy usage, comprising:
monitoring overall energy demand in at least a portion of a utility system from a central control location;
transmitting demand modification signals to a plurality of home energy management systems; and
transmitting demand modification signals from at least one of the plurality of home energy management systems to at least one home appliance to modify its energy consumption.

10. A method as in claim 9, wherein said at least one home appliance is configured to control its own energy usage in accordance with instructions from its home energy management system.

11. A method as in claim 10, further comprising:
operating the at least one home appliance using a duty cycle based on criteria provided by instructions from its home energy management system.

12. A method as in claim 9, further comprising:
generating duty cycle control signals in said home energy management system for transmission to said at least one home appliance; and
operating said at least one home appliance based on instructions received from said home energy management system.

13. A method as in claim 9, further comprising:
transmitting demand modification signals to at least one additional home appliance to modify its energy consumption; and
controlling each of the at least one and at least one additional appliances to achieve an aggregate energy usage in accordance with instruction from said demand management system.

14. A method as in claim 9, further comprising:
configuring a sub group of said plurality of home energy management systems to establish a communications network among each other; and
negotiating as a sub group with said demand management system to achieve a desired aggregate level demand adjustment.

15. A method as in claim 14, further comprising:
configuring said sub group of said plurality of home energy management systems to negotiate among themselves how to meet the negotiated aggregate level.

16. A method as in claim 15, further comprising:
configuring said sub group of said plurality of home energy management systems to collectively control individual home appliances within each home to maintain a sub group negotiated energy usage level.

17. A power distribution and control system, comprising:
a central control system;
a source of power;
a plurality of power consumption locations;
at least one power consuming device located at each of said plurality of power consumption locations;
an energy management device located at each of said plurality of power consumption locations; and
and advanced metering infrastructure configured to provide communications between said central control system and each said energy management device,
wherein said central control system is configured to monitor power flow from said source of power to said plurality of power consumption locations and to direct said energy management device located at each of said plurality of power consumption locations to modify the energy usage of said at least one power consuming device located at each of said plurality of power consumption locations.

18. A system as in claim 17, wherein energy management devices from a sub group of said plurality of power consumption locations are configured to negotiate as a group with said central control system desired aggregate energy usage modification for the sub group.

19. A system as in claim 18, wherein the energy management devices from said sub group are configured to negotiate among themselves how to meet the negotiated aggregate energy usage modification.

20. A system as in claim 19, wherein the energy management devices from said sub group are configured to collectively control individual home appliances within each home to maintain said sub group negotiated energy usage modification.
